(19) United States
(12) Patent Application Publication
(10) Pub. No.: US 2024/0143331 A1
(43) Pub. Date: May 2, 2024

(54) COMPUTATION PROCESSING APPARATUS AND METHOD OF PROCESSING COMPUTATION

(71) Applicant: FUJITSU LIMITED, Kawasaki-shi (JP)

(72) Inventor: Tetsuya ODAJIMA, Kawasaki (JP)

(73) Assignee: FUJITSU LIMITED, Kawasaki-shi (JP)

(21) Appl. No.: 18/411,185

(22) Filed: Jan. 12, 2024

Related U.S. Application Data
(62) Division of application No. 17/884,602, filed on Aug. 10, 2022.

(30) Foreign Application Priority Data
Nov. 29, 2021 (JP) 2021-193201

(51) Int. Cl. G06F 9/38; G06F 1/3287; G06F 9/30

(52) U.S. Cl. CPC G06F 9/3853; G06F 1/3287; G06F 9/30038; G06F 9/3887

(57) ABSTRACT

A computation processing apparatus includes: a memory; and a processor coupled to the memory and configured to: decode instructions; execute the instructions which is decoded and operate as a plurality of sub-computation processing apparatuses in accordance with a bit width of data to be computed; and observe an operation state of the computation processing apparatus, wherein, when observing that a subset of the plurality of sub-computation processing apparatuses does not execute an instruction or instructions, the processor parallelizes the instructions and outputs the parallelized instructions.

### CROSS-REFERENCE TO RELATED APPLICATION

This application is a divisional of U.S. patent application Ser. No. 17/884,602, filed Aug. 10, 2022, which is based upon and claims the benefit of priority of the prior Japanese Patent Application No. 2021-193201, filed on Nov. 29, 2021, the entire contents of which are incorporated herein by reference.

### FIELD

The embodiments discussed herein are related to a computation processing apparatus and a method of processing computation.

### BACKGROUND

In recent year, the number of elements simultaneously executable by a single instruction, multiple data (SIMD) instruction has been increasing to improve the processing performance of computation processing apparatuses. With this type of computation processing apparatuses, depending on an application or a program, in some cases, the number of parallel pieces of data to be computed is not necessarily increased and the computation performance is not sufficiently improved. In execution of a SIMD computation instruction, since the computation units arranged in parallel operate regardless of the number of parallel pieces of data, useless power is consumed.

Japanese Laid-open Patent Publication No. 2000-47872 and U.S. Patent Application Publication No. 2009/0144523 are disclosed as related art.

### SUMMARY

According to an aspect of the embodiments, a computation processing apparatus includes: a memory; and a processor coupled to the memory and configured to: decode instructions; execute the instructions which is decoded and operate as a plurality of sub-computation processing apparatuses in accordance with a bit width of data to be computed; and observe an operation state of the computation processing apparatus, wherein, when observing that a subset of the plurality of sub-computation processing apparatuses does not execute an instruction or instructions, the processor parallelizes the instructions and outputs the parallelized instructions.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a computation processing apparatus according to an embodiment;

FIG. 2 is a block diagram illustrating an example of a computation processing apparatus according to an other embodiment;

FIG. 3 is a block diagram illustrating an example of an instruction decoder illustrated in FIG. 2;

FIG. 4 is an explanatory diagram illustrating examples of instructions that the instruction decoder illustrated in FIG. 3 decodes;

FIG. 5 is a flow chart illustrating an example of operation of the computation processing apparatus illustrated in FIG. 2;

FIG. 6 is a flow chart illustrating an example of the operation in step S40 illustrated in FIG. 5;

FIG. 7 is a block diagram illustrating an example of a computation processing apparatus according to an other embodiment;

FIG. 8 is a block diagram illustrating examples of a computation unit and an observation unit illustrated in FIG. 7; and

FIG. 9 is a block diagram illustrating an example of a computation processing apparatus according to an other embodiment.

### DESCRIPTION OF EMBODIMENTS

Accordingly, there has been proposed a technique of reducing the power consumption. This technique reduces the power consumption by stopping operation of computation units not used for computation in a case where the number of parallel pieces of data to be computed is small. There has also been proposed a technique of reducing the power consumption. This technique reduces the power consumption by changing the number of SIMD computation units to be used in accordance with an arithmetic type of an arithmetic operation.

Although the power consumption reduces with the technique of stopping operation of the computation units not used for computation in the case where the number of parallel pieces of data to be computed is small, the processing performance of a computation processing apparatus is not improved. This is similarly applicable regardless of whether an architecture improves efficiency of data transfer.

In one aspect, an object of the present disclosure is to improve processing performance of a computation processing apparatus in a case where the number of parallel pieces of data to be computed is small.

Hereinafter, embodiments will be described with reference to the drawings.

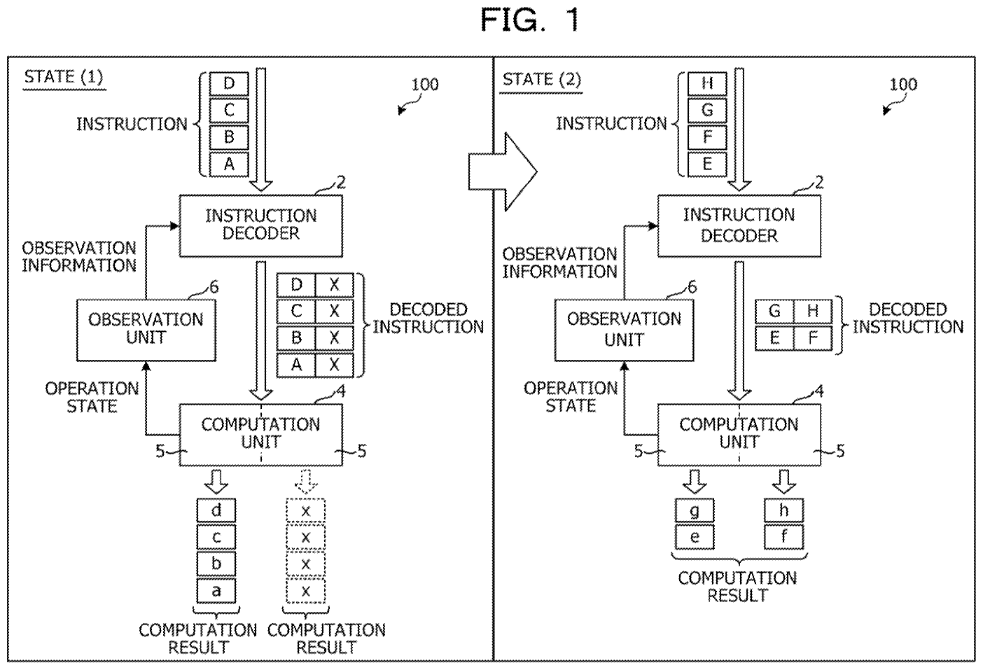

FIG. 1 illustrates an example of a computation processing apparatus according to an embodiment. A computation processing apparatus 100 illustrated in FIG. 1 is, for example, a processor such as a central processing unit (CPU) having the function of executing, for example, a plurality of product-sum computations in parallel based on a single instruction, multiple data (SIMD) computation instruction.

The computation processing apparatus 100 includes an instruction decoder 2, a computation unit 4, and an observation unit 6. The computation processing apparatus 100 may include elements that are not illustrated such as an instruction buffer and a register file other than the elements illustrated in FIG. 1. A reservation station may be disposed between the instruction decoder 2 and the computation unit 4.

The instruction decoder 2 decodes computation instructions that the instruction decoder 2 sequentially receives and outputs the decoded computation instructions to the computation unit 4. The computation unit 4 is operable as a plurality of sub-computation units 5. The computation unit 4 executes a computation by using at least one of the sub-computation units 5 based on instruction information included in the computation instructions received from the instruction decoder 2. For example, the computation unit 4 may be a SIMD computation unit that may execute a plurality of pieces of data by using the sub-computation units 5 for a single computation instruction. Hereinafter, the computation instruction is also simply referred to as an instruction.

Although the computation unit 4 may be divided into two sub-computation units 5 in FIG. 1, the number of sub-computation units 5 may be the nth power of 2 (n is an integer of 1 or greater) such as 4 or 8. For example, in a case where the bit width of data received from the instruction decoder 2 is 128 bits, the computation unit 4 executes a 128-bit computation or, as two sub-computation units 5, two 64-bit computations. Thus, the computation unit 4 is operable as a plurality of sub-computation units 5 in accordance with the bit width of data for computation. Hereinafter, it is assumed that the bit width of data to be processed by the computation unit 4 is 128 bits. However, the bit width of the data may be, for example, 256 bits or 512 bits.

The computation unit 4 has the normal computation function, the function of the SIMD computation unit, and the function of executing different instructions by using a plurality of sub-computation units 5. Based on the instruction information received from the instruction decoder 2 together with instruction code, the computation unit 4 executes a 128-bit computation, a 64-bit computation, a 64-bit SIMD computation, or 64-bit computations of two instructions using two sub-computation units 5. Thus, the computation unit 4 has the function of causing the plurality of sub-computation units 5 to execute, in parallel, computations of a plurality of pieces of data corresponding to a single instruction and the function of causing the plurality of sub-computation units 5 to respectively execute computations of a plurality of pieces of data corresponding to a plurality of instructions.

The observation unit 6 observes an operation state of the computation unit 4 and outputs to the instruction decoder 2 the operation state obtained through observation as observation information. For example, the observation unit 6 observes whether the computation unit 4 uses two sub-computation units 5 to execute a computation or uses only one sub-computation unit 5 to execute a computation and outputs the observation information to the instruction decoder 2.

Based on operation information from the observation unit 6, the instruction decoder 2 determines whether the decoded instructions are output to the computation unit 4 one by one in the decoding order or two by two in the decoding order. In states (1) and (2) illustrated in FIG. 1, the instruction decoder 2 sequentially decodes instructions A, B, C, D, E, F, G, and H. For example, each of the instructions A to H is a 64-bit instruction. At the time of decoding the instructions A, B, C, and D (before state (1)), the instruction decoder 2 receives, from the observation unit 6, the observation information indicating that the computation unit 4 is executing computations using two sub-computation units 5.

Based on the received observation information, the instruction decoder 2 determines that there is no free sub-computation unit 5 and sequentially outputs the decoded 64-bit instructions A, B, C, and D to the computation unit 4. For example, the instruction decoder 2 outputs instruction information for causing the sub-computation unit 5 on the higher-order bit side to execute the computations to the computation unit 4. In state (1), signs A, B, C, and D on the higher-order side of the decoded instructions indicate valid 64-bit data to be executed by the sub-computation unit 5 on the higher-order bit side. Signs Xs indicated on the lower-order side of the decoded instructions indicate 64-bit invalid data to be executed by the sub-computation unit 5 on the lower-order bit side.

The computation unit 4 uses two sub-computation units 5 to execute two 64-bit computations. The sub-computation unit 5 on the higher-order bit side sequentially outputs valid computation result data a, b, c, and d. The sub-computation unit 5 on the lower-order bit side sequentially outputs invalid computation result data x. For example, the sub-computation unit 5 on the lower-order bit side does not execute the instruction.

For example, in an execution cycle of the instructions A to D, the observation unit 6 observes the operation state of the computation unit 4 based on the instruction information, data, or the like supplied to the computation unit 4. The observation unit 6 outputs to the instruction decoder 2 the observation information indicating that the sub-computation unit 5 on the lower-order bit side is not executing a valid computation.

In state (2), based on the observation information received from the observation unit 6, the instruction decoder 2 determines that, regarding instructions E and F and instructions G and H, two instructions are to be executed in parallel at a time by the two sub-computation units 5. The instruction decoder 2 sequentially outputs, to the computation unit 4, instruction information for causing the computation unit 4 to execute the instructions E, F in parallel and instruction information for causing the computation unit 4 to execute the instructions G and H in parallel. Signs E and G indicated on the higher-order side of the decoded instructions indicate valid 64-bit data to be executed by the sub-computation unit 5 on the higher-order bit side. Signs F and H indicated on the lower-order side of the decoded instructions indicate valid 64-bit data to be executed by the sub-computation unit 5 on the lower-order bit side.

The computation unit 4 uses two sub-computation units 5 to execute computations of two pieces of 64-bit valid data. For example, the computation unit 4 divides two computation functions of two sub-computation units 5 so as to respectively execute a pair of instructions E and F and a pair of instructions G and H. By dividing the computation function for causing two sub-computation units 5 to independently execute the instructions, instruction execution efficiency may be improved. The sub-computation unit 5 on the higher-order bit side sequentially outputs pieces of valid computation result data e and g. The sub-computation unit 5 on the lower-order bit side sequentially outputs pieces of valid computation result data f and h. Thus, in the example illustrated in FIG. 1, in state (2), instruction processing efficiency may be doubled compared to that of state (1). For example, computation time of eight cycles taken in states (1), (2) may be reduced to six cycles (75%). As a result, processing performance of the computation processing apparatus 100 may be improved.

As described above, according to the present embodiment, in a case where the instruction decoder 2 determines that part of the sub-computation unit 5 is not executing an instruction based on the operation state of the computation unit 4 observed by the observation unit 6, the instruction decoder 2 outputs the decoded instructions to the computation unit 4 in parallel. Thus, the instructions may be executed by the sub-computation unit 5 operating uselessly. As a result, compared to a case where the observation unit 6 is not provided, the instruction processing efficiency by using the computation unit 4 may be improved, and the processing performance of the computation processing apparatus 100 may be improved.

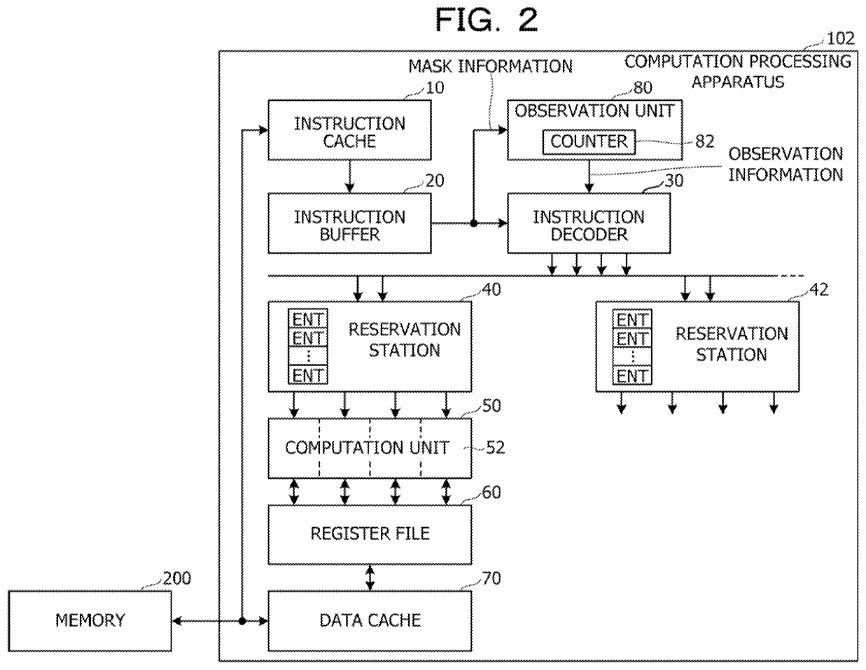

FIG. 2 illustrates an example of a computation processing apparatus according to an other embodiment. Detailed description of elements similar to those illustrated in FIG. 1 is omitted. A computation processing apparatus 102 illustrated in FIG. 2 is, as is the case with the computation processing apparatus 100 illustrated in FIG. 1, a processor such as a CPU having the function of executing, for example, a plurality of product-sum computations in parallel based on a SIMD computation instruction.

The computation processing apparatus 102 includes an instruction cache 10, an instruction buffer 20, an instruction decoder 30, reservation stations 40, 42, a computation unit 50, a register file 60, a data cache 70, and an observation unit 80.

The instruction cache 10 holds instructions to be executed by the computation unit 50 and outputs the held instructions to the instruction buffer 20. In a case where the instruction cache 10 does not hold an instruction corresponding to an address indicated by a program counter, the instruction cache 10 outputs an access request to a lower memory 200 coupled to the computation processing apparatus 102 and extracts the instruction from the memory 200. For example, the instruction cache 10 is a primary instruction cache. The memory 200 is a secondary cache or a main memory.

The instruction buffer 20 sequentially holds the instructions output from the instruction cache 10 and outputs a plurality of instructions (for example, four instructions) out of the held instructions to the instruction decoder 30 in an in-order manner.

The instruction decoder 30 decodes each of the plurality of instructions output from the instruction buffer 20 and outputs a plurality of instructions including instruction information obtained by the decoding to the reservation station 40 or the reservation station 42 in an in-order manner. The instruction decoder 30 outputs floating-point-number computation instructions to the reservation station 40 and outputs a fixed-point-number computation instructions to the reservation station 42. Hereinafter, in a case where a floating-point-number computation instruction and a fixed-point-number computation instruction are not distinguished from each other, a computation instruction is simply referred to as a computation instruction or an instruction.

For example, the instruction decoder 30 may decode a maximum of four instructions in parallel and output, in parallel, a plurality of instructions including a plurality of pieces of the instruction information obtained by decoding. The instruction decoder 30 may output a maximum of two instructions in parallel to each of the reservation stations 40 and 42. As will be described later, the instruction decoder 30 decodes instructions one at a time, two at a time, or four at a time based on the observation information received from the observation unit 80 and supplies the decoded instructions to a single entry ENT of the reservation station 40.

The reservation station 40 has a plurality of entries ENT that hold floating-point-number computation instructions in order of decoding performed by the instruction decoder 30. The reservation station 40 outputs instructions held in the entries ENT to the computation unit 50 in an executable order (out-of-order).

In a case where a single instruction is held in the entry ENT, the reservation station 40 outputs the single instruction to the computation unit 50. In a case where two instructions are held in the entries ENT, the reservation station 40 outputs two instructions to the computation unit 50 in parallel. In a case where four instructions are held in the entries ENT, the reservation station 40 outputs four instructions to the computation unit 50 in parallel.

The reservation station 42 has a plurality of entries ENT that hold fixed-point-number computation instructions in order of decoding performed by the instruction decoder 30. The reservation station 42 outputs instructions held in the entries ENT to an integer computation unit (not illustrated) in the executable order.

The computation unit 50 executes instructions based on the instruction information included in the computation instructions received from the instruction decoder 30. For example, the computation unit 50 may execute a 256-bit floating-point-number computation. The computation unit 50 may operate as four sub-computation units 52 that execute four 64-bit floating-point-number computations, respectively. The computation unit 50 has the normal computation function, the function of the SIMD computation unit, and the function of executing different instructions by using a plurality of sub-computation units 52.

Based on the instruction information received from the instruction decoder 30 together with instruction code, the computation unit 50 executes a 256-bit computation, two 128-bit SIMD computations, or four 64-bit SIMD computations. The computation unit 50 executes two 128-bit computations corresponding to two instructions or four 64-bit computation corresponding to four instructions. Thus, the computation unit 50 has the function of causing the plurality of sub-computation units 52 to execute, in parallel, computations of a plurality of pieces of data corresponding to a single instruction and the function of causing the plurality of sub-computation units 52 to respectively execute computations of a plurality of pieces of data corresponding to a plurality of instructions.

The register file 60 includes a plurality of registers that hold computation results and data (operands) used for computations. The operands held in the register file 60 are transferred from the data cache 70, and the computation results held in the register file 60 are transferred to the data cache 70.

The data cache 70 holds part of data held by the memory 200 in units of cache lines. For example, the data cache 70 is a primary data cache. In a case where the data cache 70 holds data to be computed by the computation unit 50 (cache hit), the data cache 70 transfers the held data to the register file 60. In contrast, in a case where the data cache 70 does not hold data to be computed by the computation unit 50 (cache miss), the data cache 70 reads, from the memory 200, data of a cache line including data to be computed. The data cache 70 transfers the data included in the cache line read from the memory 200 to the register file 60 and holds the data of the cache line.

The observation unit 80 observes an operation state (for example, an operation rate) of the computation unit 50 based on a floating-point-number computation instruction transferred from the instruction buffer 20 to the instruction decoder 30. The observation unit 80 outputs to the instruction decoder 30 the operation state obtained through observation as observation information. The observation unit 80 includes a counter 82 that counts the consecutive number of 128-bit or 64-bit computation instructions.

For example, the observation unit 80 updates the counter 82 for each computation instruction while 128-bit computation instructions are consecutive and resets the counter 82 when an instruction that is not a 128-bit computation instruction appears. Similarly, the observation unit 80 updates the counter 82 for each computation instruction while 64-bit computation instructions are consecutive and resets the counter 82 when an instruction that is not a 64-bit computation instruction appears. The observation unit 80 outputs to the instruction decoder 30 observation information indicating that the consecutive number of computation instructions of the same type has reached a predetermined number.

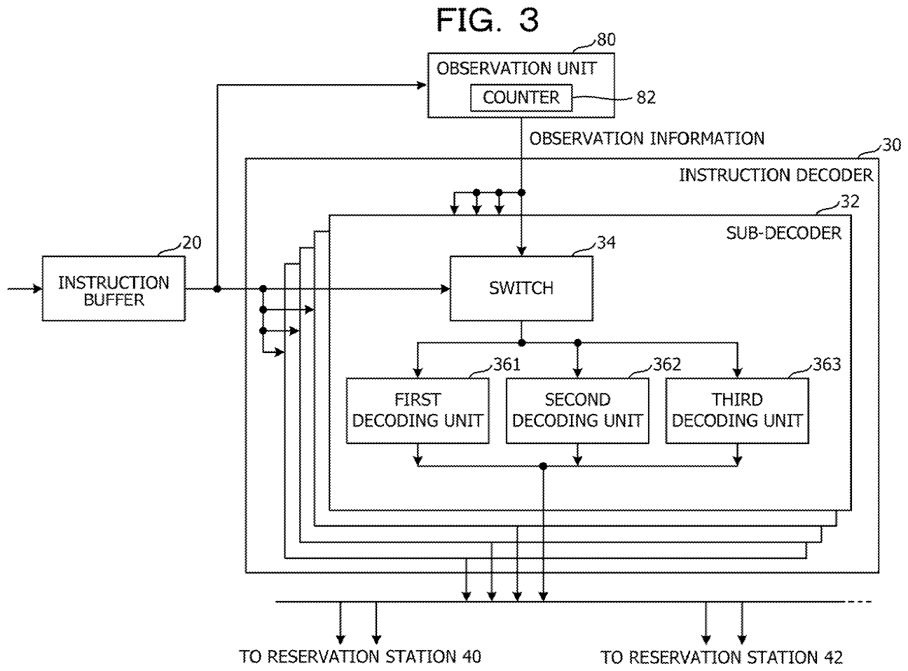

For example, the observation unit 80 determines the number of bits of a computation instruction based on mask information included in an operand of a floating-point-number computation instruction. For example, the observation unit 80 observes, based on the mask information, the number of sub-computation units 52 used by the computation unit 50 to execute a computation. The observation unit 80 outputs, as the observation information to the instruction decoder 30, the fact that the predetermined number of computations using one or two sub-computation unit 52 are consecutive. Operations of the observation unit 80 and the instruction decoder 30 will be described later with reference to FIG. 3 and the drawings following FIG. 3.

The observation unit 80 may observe the operation state of the computation unit 50 based on a fixed-point-number computation instruction transferred from the instruction buffer 20 to the instruction decoder 30. The observation unit 80 may output, as the observation information to the instruction decoder 30, the fact that the predetermined number of computations using one or two sub-computation units 52 are consecutive.

FIG. 3 illustrates an example of the instruction decoder 30 illustrated in FIG. 2. An example in which the instruction decoder 30 decodes floating-point-number computation instructions is described below. The instruction decoder 30 includes four sub-decoders 32 that respectively decode four instructions received from the instruction buffer 20. The functions of the sub-decoders 32 are identical to each other. The sub-decoders 32 each include a switch 34, a first decoding unit 361, a second decoding unit 362, and a third decoding unit 363.

Based on the observation information from the observation unit 80, the switch 34 outputs the instruction received from the instruction decoder 30 to one of the first decoding unit 361, the second decoding unit 362, and the third decoding unit 363. In a case where the observation information indicates neither continuation of execution of the 128-bit computation instructions (2 SIMD) using two sub-computation units 52 nor continuation of execution of the 64-bit computation instructions using a single sub-computation unit 52, the switch 34 outputs the instruction to the first decoding unit 361.

In a case where the observation information indicates the predetermined number of consecutive executions of the 128-bit computation instructions using two sub-computation units 52, the switch 34 outputs the instruction to the second decoding unit 362. In a case where the observation information indicates the predetermined number of consecutive executions of the 64-bit computation instructions using a single sub-computation unit 52, the switch 34 outputs the instruction to the third decoding unit 363.

The first decoding unit 361 decodes the computation instruction transferred via the switch 34 and outputs the decoded computation instruction to the reservation station 40. For example, the first decoding unit 361 decodes a 256-bit computation instruction (4 SIMD), a 128-bit computation instruction (2 SIMD), or a 64-bit computation instruction.

The second decoding unit 362 decodes two 128-bit computation instructions sequentially transferred via the switch 34. The second decoding unit 362 outputs the two decoded 128-bit computation instructions, in parallel, to a single entry ENT of the reservation station 40. The two 128-bit computation instructions are executed in parallel in the computation unit 50 by using two higher-order sub-computation units 52 and two lower-order sub-computation units 52.

The third decoding unit 363 decodes four 64-bit computation instructions sequentially transferred via the switch 34. The third decoding unit 363 outputs the four decoded 64-bit computation instructions, in parallel, to a single entry ENT of the reservation station 40. The four 64-bit computation instructions are executed in parallel in the computation unit 50 by using four sub-computation units 52.

The reservation station 40 stores the instruction received from the first decoding unit 361 in a single entry ENT on a reception basis, the two instructions received in parallel from the second decoding unit 362 in a single entry ENT on a reception basis, and the four instructions received in parallel from the third decoding unit 363 in a single entry ENT on a reception basis. The reservation station 40 outputs the instructions held in the entry ENT to the computation unit 50 in the executable order.

Also in a case where the switch 34 receives fixed-point-number computation instructions, the switch 34 may output the instructions to any one of the first decoding unit 361, the second decoding unit 362, and the third decoding unit 363 based on the observation information as in the case where the switch 34 receives the floating-point-number computation instructions. In this case, the first decoding unit 361 decodes the received computation instruction and outputs the decoded computation instruction to the reservation station 42. The second decoding unit 362 decodes two received 128-bit fixed-point-number computation instructions (2 SIMD) and outputs to a single entry ENT of the reservation station 42. The third decoding unit 363 outputs four received 64-bit fixed-point-number computation instructions to a single entry ENT of the reservation station 42.

Operation of the reservation station 42 is similar to the operation of the reservation station 40. In a case where the switch 34 receives a load instruction or a store instruction from the instruction buffer 20, the switch 34 outputs the received instruction to the first decoding unit 361 independently of the observation information.

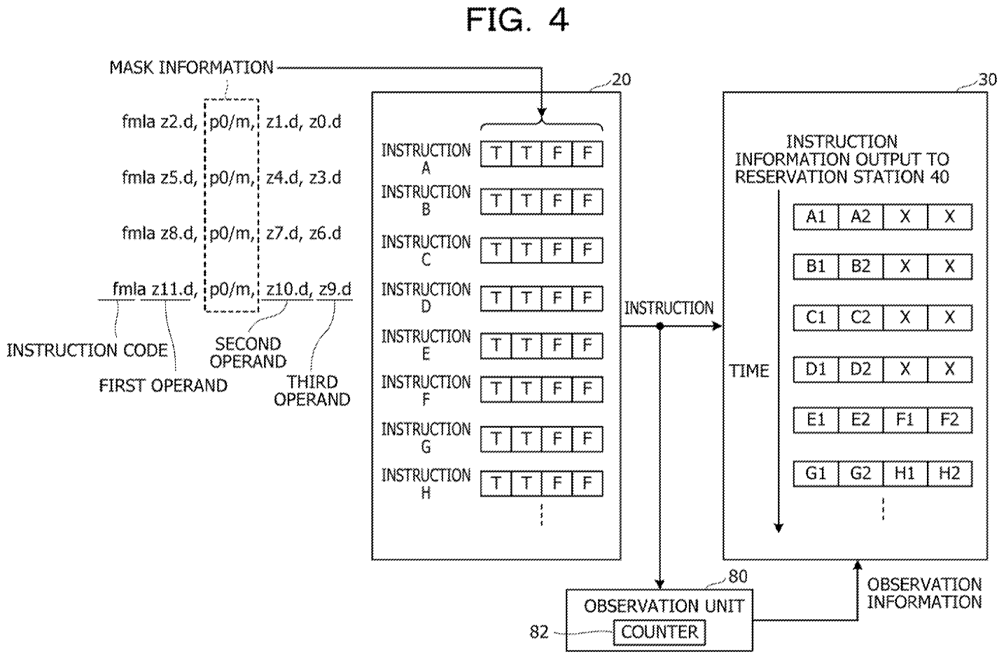

FIG. 4 illustrates examples of instructions that the instruction decoder 30 illustrated in FIG. 3 decodes. In the example illustrated in FIG. 4, the instruction decoder 30 consecutively decodes product-sum computation instructions of a 128-bit floating-point number (2 SIMD). In this example, the instruction buffer 20 holds at least eight instructions A to H and outputs the instructions to the instruction decoder 30 sequentially from the instruction A. Since the eight instructions A to H are not in dependency relationships with each other in terms of data, it is assumed that the reservation station 40 may input the instructions to the computation unit 50 in this order.

A product-sum computation instruction includes, for example, an instruction code fmla, a first operand, the mask information, a second operand, and a third operand. The second operand and the third operand (source operands) indicate numbers of the registers that hold data to be multiplied. The first operand (destination operand) indicates a number register to which a multiplication result is added.

The mask information includes four mask bits corresponding to the four sub-computation units 52 in FIG. 2. The mask bits denoted by sign T indicate that the corresponding sub-computation units 52 are caused to execute computations. The mask bits denoted by sign F indicate that the corresponding sub-computation units 52 are not caused to execute computations.

The observation unit 80 uses the counter 82 to count the number of 128-bit computation instructions transferred from the instruction buffer 20 to the instruction decoder 30. Based on the fact that the count value of the counter 82 has reached a predetermined number (=“4”) by counting the number of four instructions A to D, the observation unit 80 outputs to the instruction decoder 30 the observation information indicating that the consecutive number of instructions has reached the predetermined number.

Before receiving the observation information, the instruction decoder 30 decodes the 128-bit instructions A to D and outputs the decoded instructions to the reservation station 40. For example, the instruction information of each of the instructions A to D includes a direction for using two sub-computation units 52 on the higher-order bit side. Signs A1, A2, . . . , D1, and D2 of the instructions A to D indicate, for example, data to be used in the sub-computation units 52.

Sign X corresponding to each of the instructions A to D indicate 64-bit invalid data to be executed by the sub-computation units 52 on the lower-order bit side. The reservation station 40 holds the received instructions A to D in the entry ENT together with the invalid data and inputs to the computation unit 50 the instructions starting from executable instructions. For example, the computation unit 50 sequentially executes the instructions A to D by using a predetermined clock frequency.

Based on the reception of the observation information, the instruction decoder 30 outputs in parallel two instructions E and F and two instructions G and H to the reservation station 40. The reservation station 40 holds a pair of received instructions E and F and a pair of received instructions G and H in a single entry ENT, and the reservation station 40 inputs the pairs of instructions to the computation unit 50 starting from an executable instruction pair. For example, the computation unit 50 sequentially executes each of the pair of instructions E and F and the pair of instructions G and H by using a predetermined clock frequency. As a result, as is the case with the above-described embodiment, the instruction processing efficiency may be improved, and the processing performance of the computation processing apparatus 102 may be improved.

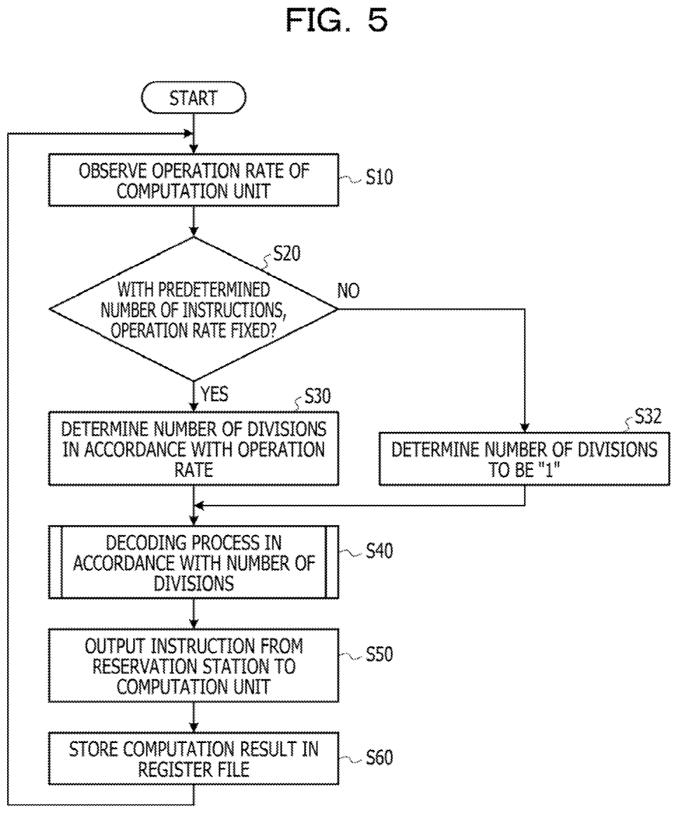

FIG. 5 illustrates an example of the operation of the computation processing apparatus 102 illustrated in FIG. 2. First, in step S10, the observation unit 80 observes the operation rate of the computation unit 50. For example, the observation unit 80 observes the operation rate of the computation unit 50 based on the mask information included in each instruction transferred from the instruction buffer 20 to the instruction decoder 30.

For example, in a case where all the four pieces of mask information of each instruction are “T”, the operation rate is 100%. In a case where two of the four pieces of mask information of each instruction are “T” and the remaining pieces of mask information are “F”, the operation rate is 50%. In a case where one of the four pieces of mask information of each instruction is “T” and the remaining piece of mask information is “F”, the operation rate is 25%.

Next, in step S20, the observation unit 80 determines whether the operation rate with a predetermined number of instructions is fixed. Although it is not particularly limiting, in the example illustrated in FIG. 4, the predetermined number is “4”. In a case where the operation rate with the predetermined number of instructions is fixed, the observation unit 80 outputs the observation information indicating the operation rate to the instruction decoder 30. After that, the operation of the computation processing apparatus 102 moves to step S30. In a case where the operation rate with the predetermined number of instructions is not fixed, the observation unit 80 outputs to the instruction decoder 30 the observation information indicating that the operation rate is not fixed. After that, the operation of the computation processing apparatus 102 moves to step S32. The state that the operation rate is fixed indicates that the operation rate is maintained at 100%, 50% or 25%.

At step S30, the instruction decoder 30 determines the number of divisions of the computation function of the computation unit 50 in accordance with the operation rate indicated by the observation information received from the observation unit 80. For example, in a case where the operation rate exceeds 50%, the instruction decoder 30 determines that each instruction is executed with the computation function of the four sub-computation units 52 undivided (the number of divisions=“1”). The case where the operation rate exceeds 50% includes a case where execution of a 256-bit computation instruction is dominant.

In a case where the operation rate is 50%, for example, in a case where 128-bit computation instructions are consecutive, the instruction decoder 30 determines that the computation function is divided into two higher-order sub-computation units 52 and two lower-order sub-computation units 52 to execute two instructions in parallel (the number of divisions=“2”). In a case where the operation rate is 25%, for example, in a case where 64-bit computation instructions are consecutive, the instruction decoder 30 determines that the computation function is divided into four sub-computation units 52 to execute four instructions in parallel (the number of divisions=“4”). After step S30, the operation of the computation processing apparatus 102 moves to step S40.

In step S32, since the observation information received from the observation unit 80 indicates that the operation rate is not fixed, the instruction decoder 30 determines that each instruction is executed with the computation function of the four sub-computation units 52 undivided (the number of divisions=“1”). After step S32, the operation of the computation processing apparatus 102 moves to step S40.

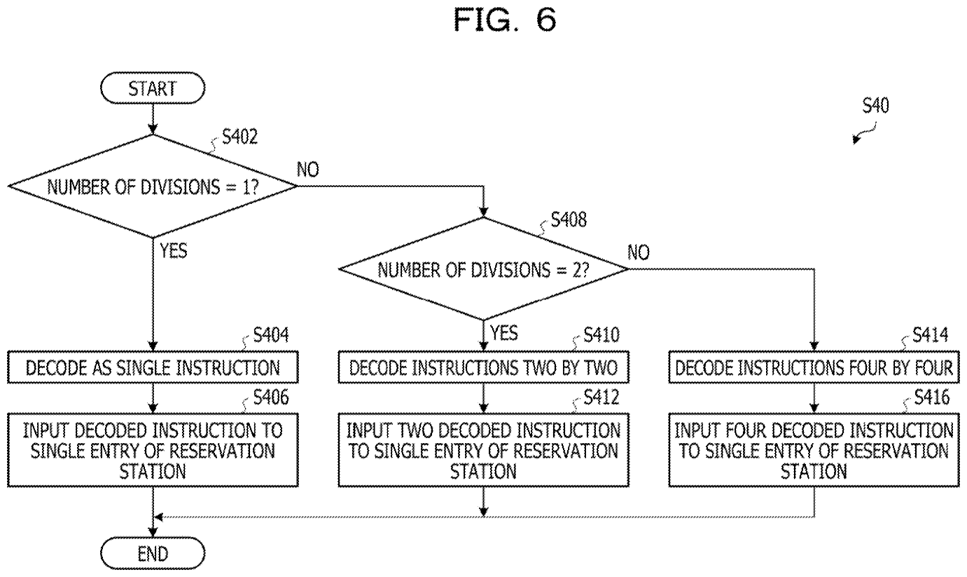

Next, in step S40, the instruction decoder 30 executes a decoding process in accordance with the number of divisions determined in step S30 and outputs the decoded instructions to the reservation station 40. An example of the operation in step S40 is illustrated in FIG. 6.

Next, in step S50, the reservation station 40 inputs the instructions to the computation unit 50 in the executable order. Next, in step S60, the computation unit 50 executes the instructions input from the reservation station 40 and stores computation results in the register file. After step S60, the computation processing apparatus 102 returns the operation to step S10.

The computation processing apparatus 102 executes a computation process by using a pipeline operation. Thus, each step illustrated in FIG. 5 is executed in an overlapping manner. For example, steps S10 and S20 are repeatedly executed, and steps S30 and S40 or steps S32 and S40 are repeatedly executed. Step S50 is repeatedly executed, and step S60 is repeatedly executed.

FIG. 6 illustrates an example of the operation in step S40 illustrated in FIG. 5. First, in step S402, the instruction decoder 30 determines whether the number of divisions determined in step S30 and S32 illustrated in FIG. 5 is “1”. In a case where the number of divisions is “1”, the instruction decoder 30 executes step S404, and in a case where the number of divisions is not “1”, the instruction decoder 30 executes step S408.

In step S404, the instruction decoder 30 decodes each of the instructions received from the instruction buffer 20 as a single instruction by using the first decoding unit 361. Next, in step S406, the instruction decoder 30 inputs the decoded instruction to a single entry ENT of the reservation station 40 and ends the operation in step S40.

In step S408, the instruction decoder 30 determines whether the number of divisions determined in step S30 and S32 illustrated in FIG. 5 is “2”. In a case where the number of divisions is “2”, the instruction decoder 30 executes step S410. In a case where the number of divisions is not “2”, since the number of divisions is “4”, the instruction decoder 30 executes step S414. In step S410, the instruction decoder 30 decodes the instructions received from the instruction buffer 20 two by two by using the second decoding unit 362. Next, in step S412, the instruction decoder 30 inputs two decoded instructions to a single entry ENT of the reservation station 40 and ends the operation in step S40.

In step S414, the instruction decoder 30 decodes the instructions received from the instruction buffer 20 four by four by using the third decoding unit 363. Next, in step S416, the instruction decoder 30 inputs four decoded instructions to a single entry ENT of the reservation station 40 and ends the operation in step S40.

As described above, also according to the present embodiment, effects similar to those of the above-described embodiment may be obtained. For example, the instruction decoder 30 determines the number of divisions of the computation function of the computation unit 50 based on the operation rate of the computation unit 50 observed by the observation unit 80 and decodes the instructions to be executed in parallel by the computation unit 50 in accordance with the determined number of divisions. As a result, compared to a case where the observation unit 80 is not provided, the instruction processing efficiency by using the computation unit 50 may be improved, and the processing performance of the computation processing apparatus 102 may be improved.

According to the present embodiment, the observation unit 80 may calculate the operation rate of the computation unit 50 based on the mask information included in each instruction transferred from the instruction buffer 20 to the instruction decoder 30. Based on the operation rate calculated from the mask information, the instruction decoder 30 decodes one, two, or four instructions and stores the decoded instructions in a single entry ENT of the reservation station 40. Thus, the operation rate of the computation unit 50 may be calculated without directly detecting the operation state of the computation unit 50, and instructions that improve the processing efficiency of the computation unit 50 may be decoded based on the calculated operation rate.

Before the instructions to be observed by the observation unit 80 is supplied to the computation unit 50, the operation rate of the computation unit 50 may be observed (predicted). For example, before the instructions to be observed by the observation unit 80 is decoded by the instruction decoder 30, the operation rate of the computation unit 50 may be observed (predicted). Since the operation rate may be predicted, a determination process of the number of divisions of the computation unit 50 and the decoding process of the instructions based on the determined number of divisions may be executed without reducing the clock frequency. For example, an increase in processing time due to an increase in the circuit size of the instruction decoder 30 may be absorbed.

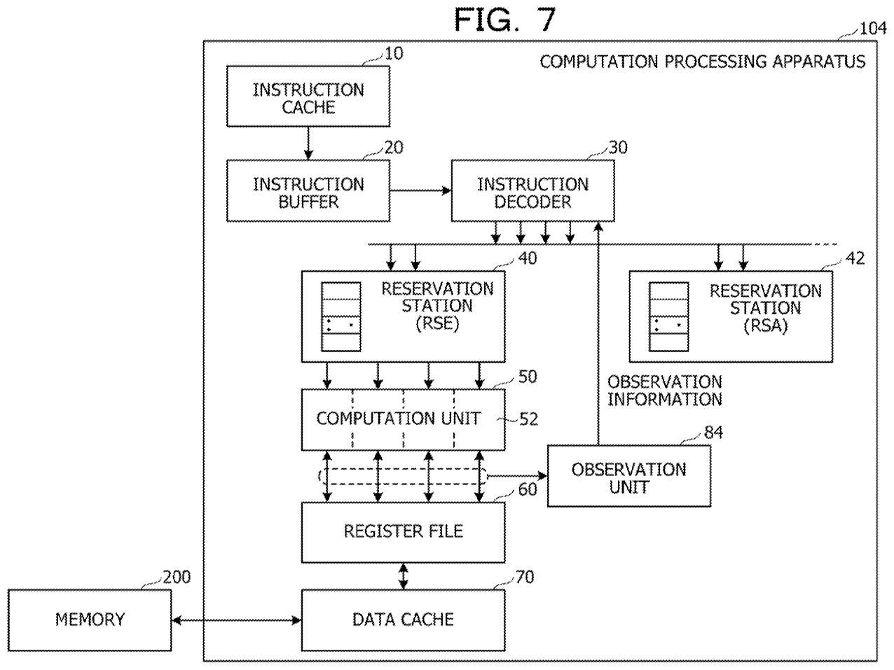

FIG. 7 illustrates an example of a computation processing apparatus according to an other embodiment. Elements similar to those illustrated in FIG. 2 are denoted by the same signs, and detailed description thereof is omitted. A computation processing apparatus 104 illustrated in FIG. 7 is, as is the case with the computation processing apparatus 102 illustrated in FIG. 2, a processor such as a CPU having the function of executing, for example, a plurality of product-sum computations in parallel based on a SIMD computation instruction.

The computation processing apparatus 104 illustrated in FIG. 7 includes an observation unit 84 instead of the observation unit 80 illustrated in FIG. 2. The configurations and functions other than those of the observation unit 84 of the computation processing apparatus 104 are similar to the configurations and functions of the computation processing apparatus 102 illustrated in FIG. 2. The observation unit 84 observes the operation state of the computation unit 50 based on data transferred from the register file 60 to the computation unit 50. The observation unit 80 outputs to the instruction decoder 30 the operation state obtained through observation as observation information.

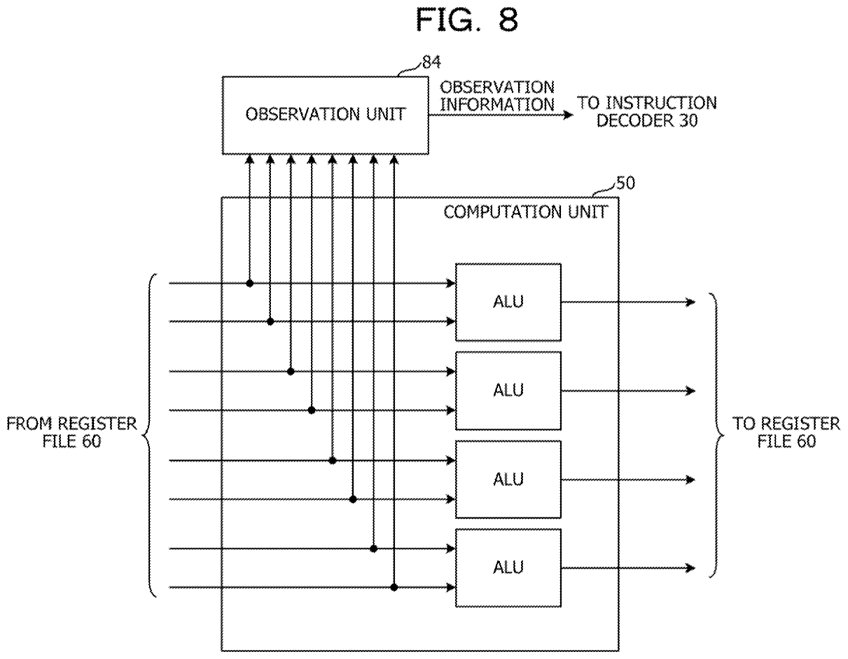

FIG. 8 illustrates examples of the computation unit 50 and the observation unit 84 illustrated in FIG. 7. The computation unit 50 includes four arithmetic logic units (ALUs) as the sub-computation units 52 illustrated in FIG. 2. For example, each ALU has two inputs for receiving source operand data and one output for outputting destination operand data. For example, the computation processing apparatus 104 has an architecture in which source operand data of “0” is supplied to an ALU that does not execute a computation.

Based on the source operand data supplied to the two inputs of each ALU, the observation unit 84 observes the operation state of the computation unit 50. For example, the observation unit 84 observes the operation state of the computation unit 50 based on the source operand data transferred from the register file 60 to each ALU.

The observation unit 84 determines that ALUs that receive source operand data of “0” consecutively a predetermined number of times at two inputs are non-operating ALUs. The observation unit 84 outputs to the instruction decoder 30 the observation information including information on the ALUs that have been determined as non-operating ALUs. Thus, the observation unit 84 may observe the operation rate of the computation unit 50 based on the source operand data.

Based on the observation information, the instruction decoder 30 outputs instructions to be executed by the operating ALUs and instructions to be executed by the non-operating ALUs to a single entry ENT of the reservation station 40. For example, the operation of the instruction decoder 30 and the computation unit 50 of the computation processing apparatus 104 according to the present embodiment may be indicated by the operation of the computation unit 50 illustrated in FIG. 4.

In the computation unit 50 illustrated in FIG. 4, signs A1, A2, . . . , D1, D2, E1, E2, G1, and G2 indicate instructions executed by two operating ALUs. Sign F1, F2, H1, and H2 indicate instructions executed by two ALUs that normally do not operate. For example, when the instruction decoder 30 decodes the instructions D (D1 and D2), the instruction decoder 30 receives the observation information including information on the ALUs that have been determined as non-operating from the observation unit 84.

From the next instructions E (E1 and E2), the instruction decoder 30 outputs the instructions E and F (F1 and F2) to a single entry ENT of the reservation station 40. Thus, the computation processing apparatus 104 may improve the processing performance as is the case with the computation processing apparatus 102. An example of operation of the computation processing apparatus 104 is similar to the operating flow of the computation processing apparatus 102 illustrated in FIGS. 5 and 6.

As described above, also according to the present embodiment, effects similar to those of the above-described embodiments may be obtained. In addition, according to the present embodiment, the observation unit 84 may directly observe the operation rate of the computation unit 50 based on the source operand data supplied to the two inputs of each ALU. The instruction decoder 30 decodes one, two, or four instructions based on the directly observed operation rate of the computation unit 50. Thus, instructions that improve the processing efficiency of the computation unit 50 may be decoded.

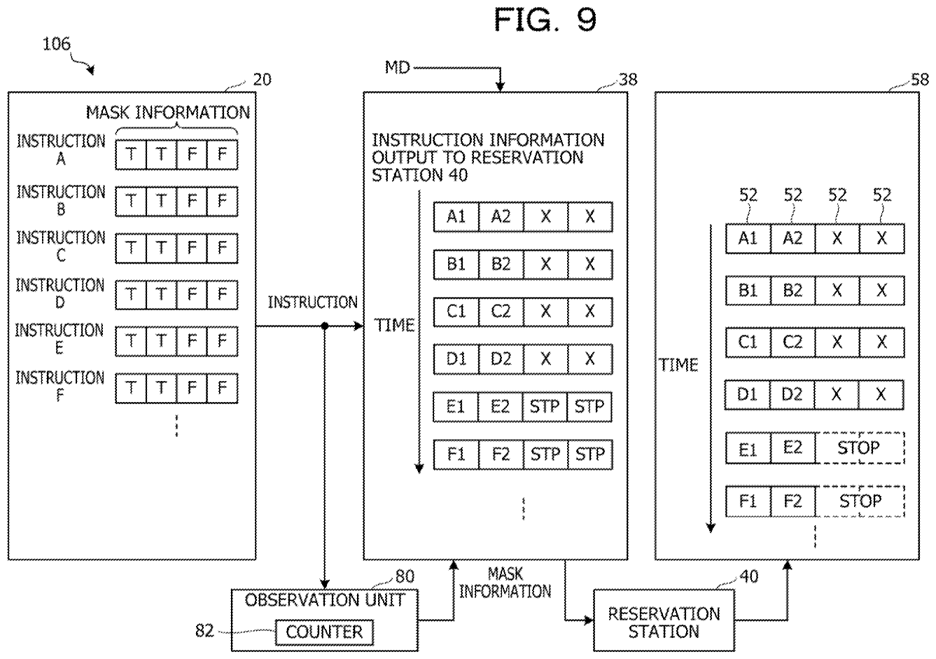

FIG. 9 illustrates an example of a computation processing apparatus according to an other embodiment. Elements similar to those of the above-described embodiments are denoted by the same signs, and detailed description thereof is omitted. A computation processing apparatus 106 illustrated in FIG. 9 includes an instruction decoder 38 and a computation unit 58 instead of the instruction decoder 30 and the computation unit 50 illustrated in FIG. 2. The configurations and functions other than those of the instruction decoder 38 and the computation unit 58 of the computation processing apparatus 106 are similar to the configurations and functions of the computation processing apparatus 102 illustrated in FIG. 2.

The instruction decoder 38 has a circuit and a function of receiving mode information MD in addition to the configuration and function of the instruction decoder 30 illustrated in FIG. 3. The mode information MD indicates either a performance priority mode or a low power mode of the computation unit 50. The mode information MD may be generated in the computation processing apparatus 106 or supplied from the outside of the computation processing apparatus 106.

In a case where the mode information MD indicating the performance priority mode is received, the instruction decoder 38 switches an operation mode to the performance priority mode and executes the operating flows illustrated in FIGS. 5 and 6. This may improve the processing performance of the computation unit 50.

In a case where the mode information MD indicating the low power mode is received, the instruction decoder 38 switches the operation mode to the low power mode. The instruction decoder 30 embeds stop information STP that causes stopping of the operation of the sub-computation units 52 that do not execute instructions in the decoded instructions and outputs the instructions in which the stop information STP is embedded to the reservation station 40.

The configuration and function of the observation unit 80 are similar to the configuration and function of the observation unit 80 illustrated in FIGS. 2 and 3. The configuration and function of the reservation station 40 are similar to the configuration and function of the reservation station 40 illustrated in FIG. 2.

In addition to the configuration and function of the computation unit 50 illustrated in FIGS. 2 and 4, the computation unit 58 has the function of stopping the operation of the sub-computation units 52 corresponding to the stop information STP. For example, the operation of the sub-computation units 52 is executed by stopping a clock supplied to the sub-computation units 52.

An example of the operation of the sub-computation units 52 in the low power mode is illustrated in the computation unit 58 illustrated in FIG. 9. Signs Xs in the computation unit 58 indicate the sub-computation units 52 that do not execute instructions. However, since the sub-computation units 52 that do not execute instructions execute computation for meaningless invalid data (for example, “0”) supplied to the inputs of the sub-computation units 52, the sub-computation units 52 indicated by signs Xs consume useless power.

In a case where the instruction received from the reservation station 40 includes the stop information STP, the computation unit 58 stops the operation of the sub-computation units 52 corresponding to the stop information STP. Stopping of the operation of the sub-computation units 52 that do not execute an instruction may reduce the power consumption of the computation unit 58.

As described above, also according to the present embodiment, effects similar to those of the above-described embodiments may be obtained. According to the present embodiment, the processing performance of the computation unit 58 may be improved in the performance priority mode. Also, the power consumption of the computation unit 58 may be reduced in the low power mode, and accordingly, the power consumption of the computation processing apparatus 106 may be reduced.

Regarding the embodiments illustrated in FIGS. 1 to 9, the following appendices are further disclosed.

Features and advantages of the embodiments are clarified from the foregoing detailed description. The scope of claims is intended to cover the features and advantages of the embodiments as described above within a scope not departing from the spirit and scope of right of the claims. Any person having ordinary skill in the art may easily conceive every improvement and alteration. Accordingly, the scope of inventive embodiments is not intended to be limited to that described above and may rely on appropriate modifications and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computation processing apparatus comprising:
a memory; and
a processor coupled to the memory and configured to:
decode instructions;
execute the instructions which are decoded and operate as a plurality of sub-computation processing apparatuses in accordance with a bit width of data to be computed; and
observe an operation state of the computation processing apparatus, wherein,
when observing that a subset of the plurality of sub-computation processing apparatuses does not execute an instruction or instructions, the processor parallelizes the instructions and outputs the parallelized instructions.
